(19) United States
(12) Patent Application Publication
(10) Pub. No.: US 2020/0132082 A1
(43) Pub. Date: Apr. 30, 2020

(54) WALL-ATTACHED OVERHEAD FAN MOUNT AND METHOD

(71) Applicant: Del Tanner, Lapeer, MI (US)

(72) Inventor: Del Tanner, Lapeer, MI (US)

(21) Appl. No.: 16/583,642

(22) Filed: Sep. 26, 2019

Related U.S. Application Data
(60) Provisional application No. 62/750,154, filed on Oct. 24, 2018.

(51) Int. Cl. F04D 25/08; F04D 29/60; F21V 33/00

(52) U.S. Cl. CPC F04D 25/088; F16M 13/02; F21V 33/0096; F04D 29/601

(57) ABSTRACT

A fan suspender is disclosed herein. The fan suspender includes a wall-mount able to be affixed to a wall, a fan-mount able to be affixed to a fan, and a suspension-member which rigidly affixed the fan-mount to the wall-mount and enables the fan-mount to be safely suspended over an area. In this way, an electric fan may be effectively mounted to an interior or exterior wall without need of a ceiling to permanently mount the fan to. The suspension member has a curvature, separating a first straight end and a second straight end. The wall mount has a mounting plate with a wall side and an attachment side including a receptacle able to receive the suspension-member. The fan mount has a fan-mounting-plate with a fan-side and a suspension-side including a receptacle able to receive the opposite end of the suspension member.

### CROSS-REFERENCE TO RELATED APPLICATION(S)

The present application is related to and claims priority to U.S. Provisional Patent Application No. 62/750,154 filed Oct. 24, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of household fixtures of existing art and more specifically relates to ceiling fans.

### RELATED ART

When sitting outside an RV, the lack of airflow can be stifling. On cooler days, a lack of heat can deter individuals from sitting outside. When there is no way to circulate the air, insects may accumulate in the area. Individuals also have to rely on flashlights and candles as a light source when seated under the outdoor awning. A suitable solution is desired.

U.S. Pat. No. 8,348,220 to Lee Carter relates to a portable ceiling fan mounting assembly. The described portable ceiling fan mounting assembly includes an assembly adapted for use on the exterior of a parked motorized recreational vehicle. The assembly includes an arm to which the ceiling fan and bracket for the fan is mounted. The arm has an electrical plug disposed on one end that connects the ceiling fan assembly electrically to the available power in the recreational vehicle. A mounting plate is attached to the recreational vehicle wall which receives the arm and contains an electrical receptacle for receipt of the electrical plug. The device is thus easy to handle and install and is user friendly.

### SUMMARY OF THE INVENTION

In view of the foregoing disadvantages inherent in the known ceiling fan art, the present disclosure provides a novel wall-attached overhead fan mount and method. The general purpose of the present disclosure, which will be described subsequently in greater detail, is to provide a wall-attached overhead fan mount and method.

A fan suspender is disclosed herein. The fan suspender includes a wall-mount able to be affixed to a wall, a fan-mount able to be affixed to a fan, and a suspension-member which rigidly affixed the fan-mount to the wall-mount and enables the fan-mount to be safely suspended over an area. In this way, an electric fan may be effectively mounted to an interior or exterior wall without need of a ceiling to permanently mount the fan to. The suspension member has a curvature, separating a first straight end and a second straight end. The wall mount has a mounting plate with a wall side and an attachment side including a receptacle able to receive the suspension-member. The fan mount has a fan-mounting-plate with a fan-side and a suspension-side including a receptacle able to receive the opposite end of the suspension member.

According to another embodiment, a method of mounting an overhead fan is also disclosed herein. The method of mounting an overhead fan includes providing the above-described fan suspender, affixing the wall-mounting-plate to the vertical wall with the wall-side adjacent to the vertical wall, affixing the fan-mounting-plate to the overhead fan with the fan-side adjacent to the overhead fan, sliding the first-straight-end of the suspension-member into the first-receptacle, sliding the second-straight-end of the suspension-member into the second-receptacle, and rotating each of the first-straight-end relative to the first-receptacle and the second-straight-end relative to the second-receptacle until the overhead fan is in a desired position relative to the vertical wall.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a wall-attached overhead fan mount and method, constructed and operative according to the teachings of the present disclosure.

FIG. 1 is a perspective view of the fan suspender during an ‘in-use’ condition, according to an embodiment of the disclosure.

FIG. 2 is a perspective view of the fan suspender of FIG. 1, according to an embodiment of the present disclosure.

FIG. 3 is a perspective view of the fan suspender of FIG. 1, according to an embodiment of the present disclosure.

FIG. 4 is a perspective view of the fan suspender of FIG. 1, according to an embodiment of the present disclosure.

FIG. 5 is a flow diagram illustrating a method of use for mounting an overhead fan to a vertical wall, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a household fixture and more particularly to a wall-attached overhead fan mount and method as used to improve the mounting of an overhead fan to a vertical wall.

Generally, the wall-attached overhead fan mount provides a fan suspender for mounting a removable and adjustable overhead ceiling fan, especially for outdoor awning areas of an RV. The device offers air circulation and cooling for those in the seated area under a retractable RV awning. It may include LED lighting, a heating element, and a mounting assembly that swivels to allow the ceiling fan to be positioned at different angles. The device provides a directionally adjustable heating, cooling, and lighting fixture for RV owners. The device circulates air in order to deter insects from settling in the area. The device is a removable and adjustable overhead ceiling fan for the outdoor awning area of an RV. The device can be stowed on the side of the RV for transport. The design is comprised of full square stock and flat steel mount with a rotating overhead pipe and an attached ceiling fan. The mount will secure to the camper while the extension of the bent pipe and attached ceiling fan hovers above the seating area. The ceiling fan may include LED lighting and a heating element. The assembly is designed to swivel when a set screw is released so that it may be adjusted into a variety of positions. The unit may also be utilized in a garage, work bench area, etc. The exact specifications may vary.

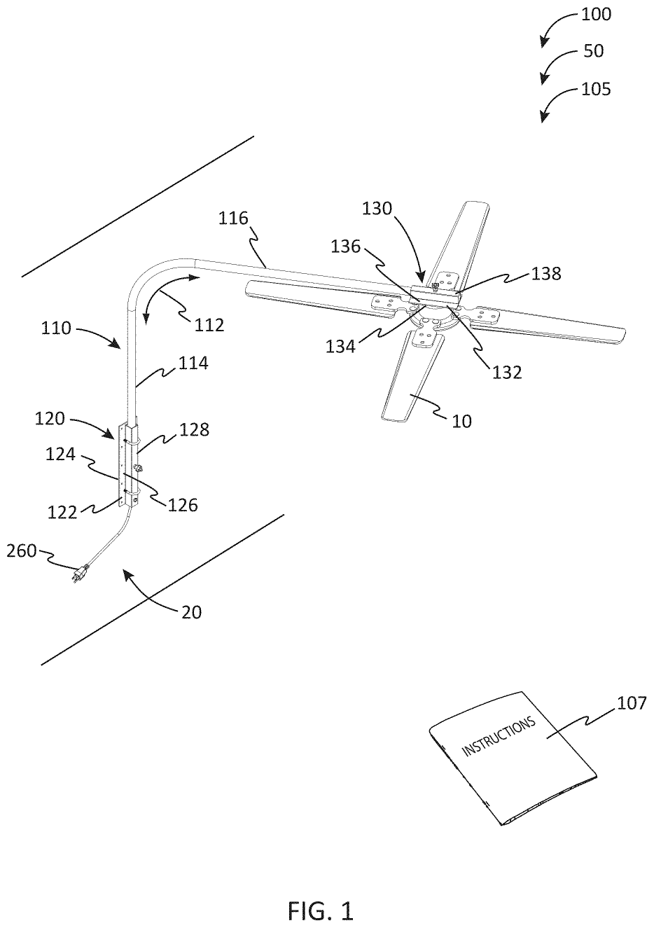

Referring now more specifically to the drawings by numerals of reference, there is shown in FIGS. 1-4, various views of a fan-suspender 100.

For the purposes of this specification, a “square tube” may indicate a hollow elongate member having four sides which are each disposed at approximately ninety degrees to each other. A “square rod” may indicate and elongate member having four sides which are each disposed at approximately ninety degrees to each other, and may be either hollow or solid. Additionally, the term “tubular” in general may not necessary require a cylindrical tube; hollow members of varying geometric cross sections may be included. For example, while the first-receptacle is described in places as tubular, the preferred embodiment utilizes a first-receptacle which is constructed of square tubing. “Substantially parallel” means not diverging from a common axial direction by more than one degree.

FIG. 1 shows a fan-mount during an ‘in-use’ condition 50, according to an embodiment of the present disclosure. Here, fan-mount 130 may be beneficial for use by a user 40 to mount an overhead fan to a vertical wall. As illustrated, fan-suspender 100 may be able to mount overhead fan 10 to vertical wall 20. Fan-suspender 100 may include suspension-member 110, wall-mount 120, and fan-mount 130. Suspension-member 110 may releasably adjoin wall-mount 120 and fan-mount 130. Wall-mount 120 may be configured to be affixed to a planar wall. Fan-mount 130 may be configured to be affixed to an electric ceiling fan. When these three components are combined, fan-suspender 100 allows a overhead fan 10 to be safely suspended within a room by affixing fan-suspender 100 to vertical wall 20, such that no mechanical interaction with a ceiling is necessary. Suspension-member 110 may itself include curvature 112, first-straight-end 114 disposed on one side of curvature 112, and second-straight-end 116 disposed on an opposite side of curvature 112 from first-straight-end 114. Wall-mount 120 may include wall-mounting-plate 122, such that wall-mounting plate 122 includes wall-side 124 and attachment-side 126, first-receptacle 128 on attachment-side 126. First-receptacle 128 may be tubular and may be able to receive first-straight-end 114 of suspension-member 110. Fan-mount 130 includes fan-mounting-plate 132 with fan-side 134 and suspension-side 136, and second-receptacle 138 which may be attached to suspension-side 136. Second-receptacle 138 may be able to receive second-straight-end 116 of suspension-member 110. Curvature 112 may be an arc which separates first-straight-end 114 and second-straight-end 116 by ninety degrees of rotation, such that first-straight-end 114 is able to align with vertical wall 20, and second-straight-end 116 is able to align with the ceiling. Fan-suspender 100 may also include electrical power supply cord 260 able to electrically couple overhead fan 10 to a power-source, electrical power supply cord 260 passing through each of suspension-member 110, wall-mount 120, and fan-mount 130. Preferably, electrical power supply cord passes through an interior of these components and is not externally visible.

According to one embodiment, the fan-mount 100 may be arranged as a kit 105. In particular, the fan-mount 100 may further include a set of instructions 107. The instructions 107 may detail functional relationships in relation to the structure of the fan-mount 100 such that the fan-mount 100 can be used, maintained, or the like, in a preferred manner.

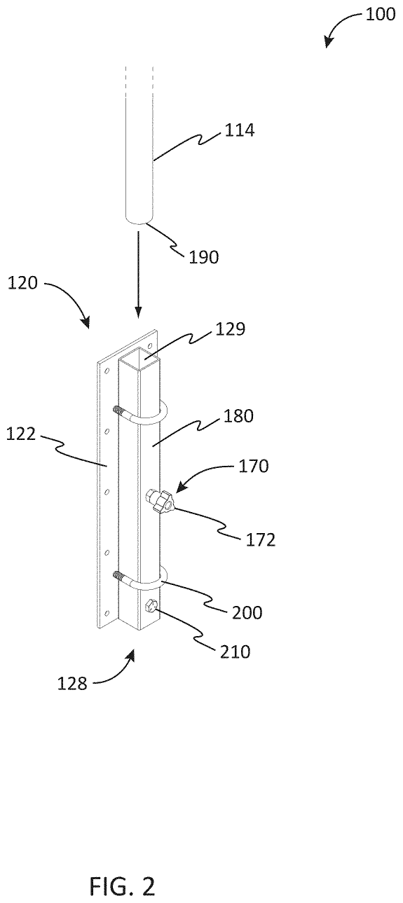

FIG. 2 shows fan-suspender of FIG. 1, according to an embodiment of the present disclosure. As shown, first-receptacle 128 of wall-mount 120 may also include set-screw 170. Set-screw 170 may be threaded, being threadable and advanceable into interior 129 of first-receptacle 128, such that when first-straight-end 114 of suspension-member 110 (FIG. 1) is installed in first-receptacle 128 of the wall mount, advancing set-screw 170 into the interior of first-receptacle 128 causes set-screw 170 to impinge against first-straight-end 114 of suspension-member 110 (FIG. 1), thereby securing first-straight-end 114 of suspension-member 110 (FIG. 1) relative to first-receptacle 128 at a selected position. First-receptacle 128 may include square tube 180, and first-straight-end 114 may have rod 190 which is able to fit into first-receptacle 128, being each dimensioned such that rod 190 is able to rotate within first-receptacle 128 when not otherwise constrained. Set-screw 170 may also have knob 172 accessible from an exterior of first-receptacle 128 enabling set-screw 170 to be advanced or retarded by hand. To accomplish this knob 172 may be rigidly affixed, or may be integral to, set-screw 170. First-receptacle 128 may be affixed to wall-mounting-plate 122 by pair of U-bolts 200. Yet further, first-receptacle 128 may have stop 210 which intersects an interior of first-receptacle 128 in order to prevent first-straight-end 114 of suspension-member 110 from passing entirely through first-receptacle 128. Stop 210 may a threaded bolt in some embodiments.

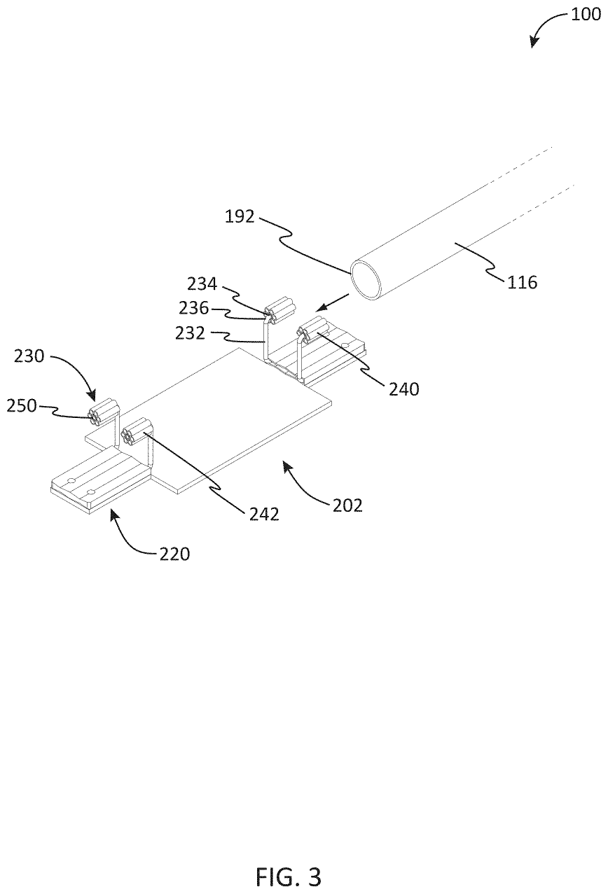

FIG. 3 is a perspective view of the fan mount of FIG. 1, according to an embodiment of the present disclosure. Second-straight-end 116 of suspension-member 110 (FIG. 1) comprises round rod, enabling second-straight-end 116 of suspension-member 110 (FIG. 1) to rotate relative to second-receptacle 138 when second-straight-end 116 is installed within second-receptacle 138. Second-receptacle 138 may include retainer 202. Retainer 202 may have pair of clamps 220. Each of clamps 220 may have pair of grips 220 affixed to fan-mounting-plate 132. Each of grips 220 may include cantilever 230 and deformable pad 240 attached to cantilever 230. Cantilever 230 may have proximal-end 232, distal-end 234, and bend 236 separating proximal-end 232 from distal-end 234, such that cantilever 230 protrudes from fan-mounting-plate 132, and proximal-end 232 is affixed to fan-mounting-plate 132. Deformable pad 240 is affixed to distal-end 234 of cantilever 230. Deformable pad 240 has perforation 250 through which distal-end 234 of cantilever 230 may pass. Deformable pad 240 includes six rounded convex corrugations 242 arrayed radially about perforation 250, each of six rounded convex corrugations 242 being able to effectively grip and constrain second-straight-end 116 of the suspension member when second-straight-end 116 of the suspension member is installed between the pair of grips of each of pair of clamps 220. Deformable pad 240 is constructed of rubber, polyurethane, or other suitable deformable and resilient materials. Cantilever 230 may be a combination component between each pair of grips, such that cantilever 230 comprises two distal-ends 234, two-proximal ends 232, and joining-member 238, joining-member 238 rigidly joining two proximal-ends 232 together, such that two distal-ends 234 are substantially parallel to each other, and two proximal-ends 234 are substantially parallel to each other.

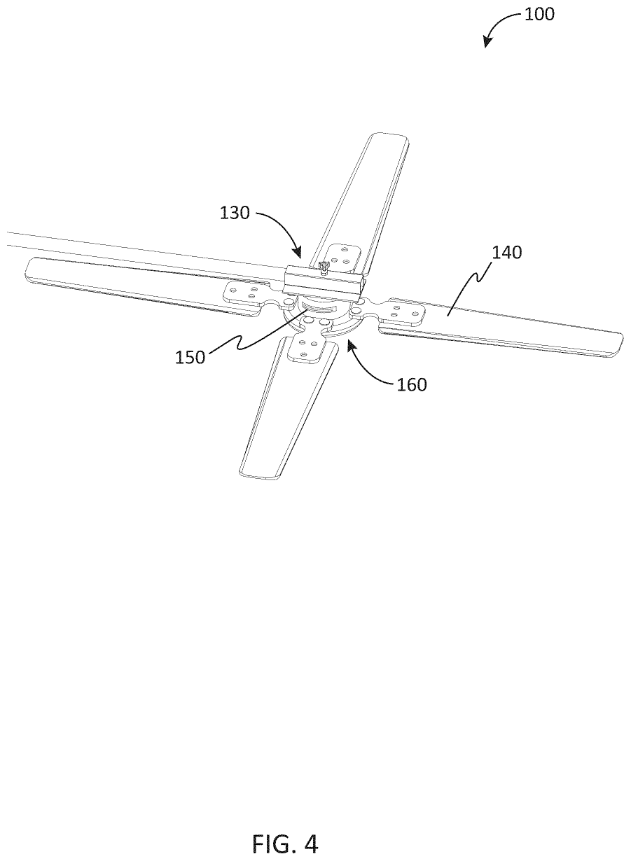

FIG. 4 is a perspective view of the fan mount and multipurpose fan attachment of FIG. 1, according to an embodiment of the present disclosure. Fan-suspender 100 may yet further include multi-purpose fan 140 affixable to fan-mount 130, the multi-purpose fan having at least one L.E.D. light array 150 and heating element 160.

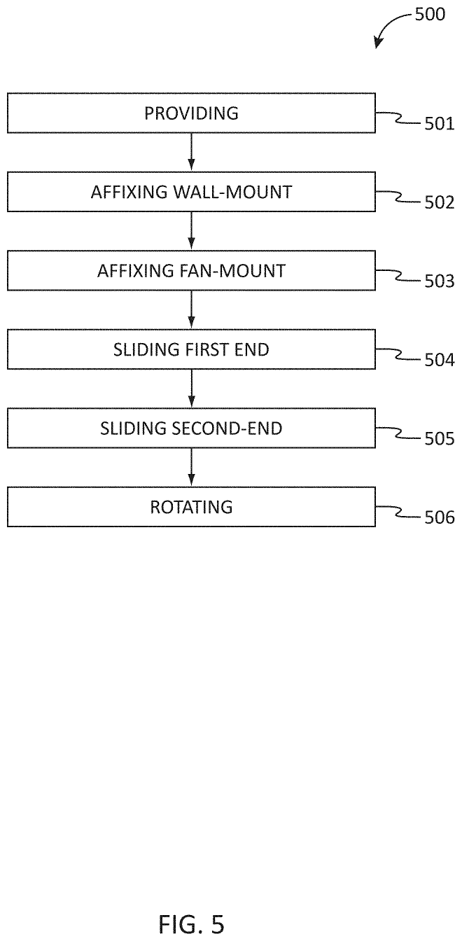

FIG. 5 is a flow diagram illustrating a method for mounting an overhead fan to a vertical wall, according to an embodiment of the present disclosure. In particular, the method for mounting an overhead fan to a vertical wall 500 may include one or more components or features of the fan-mount 100 as described above. As illustrated, the method for mounting an overhead fan to a vertical wall 500 may include the steps of: step one 501, providing a fan-suspender comprising a suspension-member having a curvature, a first-straight-end on one side of the curvature, a second-straight-end on an opposite side of the curvature from the first-straight-end, a wall-mount having a wall-mounting-plate with a wall-side and an attachment-side, a first-receptacle on the attachment-side, the first-receptacle being tubular, the first-receptacle able to receive the first-straight-end of the suspension-member, and a fan-mount having a fan-mounting-plate with a fan-side and a suspension-side, and a second-receptacle attached to the suspension-side, the second-receptacle able to receive the second-straight-end of the suspension-member; step two 502, affixing the wall-mounting-plate to the vertical wall with the wall-side adjacent to the vertical wall; step three 503, affixing the fan-mounting-plate to the overhead fan with the fan-side adjacent to the overhead fan; step four 504, sliding the first-straight-end of the suspension-member into the first-receptacle; step five 505, sliding the second-straight-end of the suspension-member into the second-receptacle; and step six 506, rotating each of the first-straight-end relative to the first-receptacle and the second-straight-end relative to the second-receptacle until the overhead fan is in a desired position relative to the vertical wall.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for mounting an overhead fan to a vertical wall, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A fan-suspender able to mount an overhead fan to a vertical wall, the fan-suspender comprising:
a suspension-member having
a curvature,
a first-straight-end on one side of the curvature,
a second-straight-end on an opposite side of the curvature from the first-straight-end,
a wall-mount having
a wall-mounting-plate with a wall-side and an attachment-side,
a first-receptacle on the attachment-side, the first-receptacle being tubular,
the first-receptacle able to receive the first-straight-end of the suspension-member; and
a fan-mount having
a fan-mounting-plate with a fan-side and a suspension-side, and
a second-receptacle attached to the suspension-side, the second-receptacle able to receive the second-straight-end of the suspension-member.

2. The fan-suspender of claim 1, wherein the curvature is an arc which separates the first-straight-end and the second-straight-end by ninety degrees of rotation, such that the first-straight-end is able to align with a vertical wall.

3. The fan-suspender of claim 1, wherein the first-receptacle comprises a square tube, and the first-straight-end comprises a rod which is able to fit into the first-receptacle, the rod being able to rotate within the first-receptacle when not otherwise constrained.

4. The fan-suspender of claim 1, further comprising a multi-purpose fan affixable to the fan-mount, the multi-purpose fan having at least one L.E.D. light array and a heating element.

5. The fan-suspender of claim 1, wherein the first-receptacle of the wall-mount further comprises a set-screw, the set-screw being threadable and advanceable into an interior of the first-receptacle, such that when the first-straight-end of the suspension-member is installed in the first-receptacle of the wall mount, advancing the set-screw into the interior of the first-receptacle causes the set-screw to imping against the first-straight-end of the suspension-member, thereby securing the first-straight-end of the suspension-member relative to the first-receptacle at a selected position.

6. The fan-suspender of claim 5, wherein the set-screw further includes a knob accessible from an exterior of the first-receptacle enabling the set-screw to be advanced or retarded by hand.

7. The fan-suspender of claim 1, wherein the first-receptacle is affixed to the wall-mounting-plate by a pair of U-bolts.

8. The fan-suspender of claim 1, wherein the first-receptacle further comprises a stop intersecting an interior of the first-receptacle in order to prevent the first-straight-end of the suspension-member from passing entirely through the first-receptacle.

9. The fan-suspender of claim 8, wherein the stop is a threaded bolt.

10. The fan-suspender of claim 1, further comprising an electrical power supply cord able to electrically couple the overhead fan to a power-source, the electrical power supply cord passing through each of the suspension-member, the wall-mount, and the fan-mount.

11. The fan-suspender of claim 1, wherein the second-straight-end of the suspension-member comprises a round rod, enabling the second-straight-end of the suspension-member to rotate relative to the second-receptacle when the second-straight-end is installed within the second-receptacle.

12. The fan-suspender of claim 1, wherein the second-receptacle comprises a pair of clamps, each of the clamps comprising
a pair of grips affixed to the fan-mounting-plate, each of the grips comprising
a cantilever comprising a proximal-end, a distal-end, and a bend separating the proximal-end from the distal-end, the cantilever protruding from the fan-mounting-plate, the proximal-end being affixed to the fan-mounting-plate, and
a deformable pad affixed to the distal-end of the cantilever, the deformable pad having a perforation through which the distal-end of the cantilever may pass.

13. The fan-suspender of claim 12, wherein the deformable pad includes six rounded convex corrugations arrayed radially about the perforation, each of the six rounded corrugations being able to effectively grip and constrain the second-straight-end of the suspension member when the second-straight-end of the suspension member is installed between the pair of grips of each of the pair of clamps.

14. The fan-suspender of claim 1, wherein the deformable pad is constructed of rubber.

15. The fan-suspender of claim 1, wherein the deformable pad is constructed of polyurethane.

16. The fan-suspender of claim 1, wherein the cantilever is a combination component between each pair of grips, such that the cantilever comprises two distal-ends, two-proximal ends, and a joining-member, the joining-member rigidly joining the two proximal-ends together, the two distal-ends being substantially parallel to each other, and the two proximal-ends being substantially parallel to each other.

17. A fan-suspender able to mount an overhead fan to a vertical wall, the fan-suspender comprising:
a suspension-member having
a curvature,
a first-straight-end on one side of the curvature,
a second-straight-end on an opposite side of the curvature from the first-straight-end,
a wall-mount having
a wall-mounting-plate with a wall-side and an attachment-side,
a first-receptacle on the attachment-side, the first-receptacle being tubular,
the first-receptacle able to receive the first-straight-end of the suspension-member; and
a fan-mount having
a fan-mounting-plate with a fan-side and a suspension-side, and
a second-receptacle attached to the suspension-side, the second-receptacle able to receive the second-straight-end of the suspension-member;
wherein the curvature is an arc which separates the first-straight-end and the second-straight-end by ninety degrees of rotation, such that the first-straight-end is able to align with a vertical wall, and the second-straight-end is able to align with a ceiling;
wherein the first-receptacle comprises a square tube, and the first-straight-end comprises a rod which is able to fit into the first-receptacle, the rod being able to rotate within the first-receptacle when not otherwise constrained;
wherein the first-receptacle of the wall-mount further comprises a set-screw, the set-screw being threadable and advanceable into an interior of the first-receptacle, such that when the first-straight-end of the suspension-member is installed in the first-receptacle of the wall mount, advancing the set-screw into the interior of the first-receptacle causes the set-screw to imping against the first-straight-end of the suspension-member, thereby securing the first-straight-end of the suspension-member relative to the first-receptacle at a selected position;
wherein the set-screw further includes a knob accessible from an exterior of the first-receptacle enabling the set-screw to be advanced or retarded by hand'
wherein the first-receptacle further comprises a stop intersecting an interior of the first-receptacle in order to prevent the first-straight-end of the suspension-member from passing entirely through the first-receptacle;
wherein the second-straight-end of the suspension-member comprises a round rod, enabling the second-straight-end of the suspension-member to rotate relative to the second-receptacle when the second-straight-end is installed within the second-receptacle;
wherein the second-receptacle comprises a pair of clamps, each of the clamps comprising
a pair of grips affixed to the fan-mounting-plate, each of the grips comprising
a cantilever comprising a proximal-end, a distal-end, and a bend separating the proximal-end from the distal-end, the cantilever protruding from the fan-mounting-plate, the proximal-end being affixed to the fan-mounting-plate, and
a deformable pad affixed to the distal-end of the cantilever, the deformable pad having a perforation through which the distal-end of the cantilever may pass.

18. The fan-suspender of claim 17, further comprising set of instructions; and
wherein the fan-mount is arranged as a kit.

19. A method of mounting an overhead fan to a vertical wall, the method comprising the steps of:
providing a fan-suspender comprising a suspension-member having a curvature, a first-straight-end on one side of the curvature, a second-straight-end on an opposite side of the curvature from the first-straight-end, a wall-mount having a wall-mounting-plate with a wall-side and an attachment-side, a first-receptacle on the attachment-side, the first-receptacle being tubular, the first-receptacle able to receive the first-straight-end of the suspension-member, and a fan-mount having a fan-mounting-plate with a fan-side and a suspension-side, and a second-receptacle attached to the suspension-side, the second-receptacle able to receive the second-straight-end of the suspension-member;
affixing the wall-mounting-plate to the vertical wall with the wall-side adjacent to the vertical wall;
affixing the fan-mounting-plate to the overhead fan with the fan-side adjacent to the overhead fan;
sliding the first-straight-end of the suspension-member into the first-receptacle;
sliding the second-straight-end of the suspension-member into the second-receptacle;
rotating each of the first-straight-end relative to the first-receptacle and the second-straight-end relative to the second-receptacle until the overhead fan is in a desired position relative to the vertical wall.
